(19) United States
(12) Patent Application Publication
(10) Pub. No.: US 2026/0340857 A1
(43) Pub. Date: Oct. 29, 2026

(54) CMS TRAILER LANDING GEAR POSITION DETECTION

(71) Applicant: Stoneridge Electronisc AB, Solna (SE)

(72) Inventors: Gabriel Lepage, Royal Oak, MI (US); Troy Cooprider, White Lake, MI (US)

(21) Appl. No.: 19/192,726

(22) Filed: Apr. 29, 2025

(51) Int. Cl. G06T 7/70; B60R 1/26

(52) U.S. Cl. CPC G06T 7/70; B60R 1/26; B60R 2300/304; B60R 2300/307; G06T 2207/30204; G06T 2207/30252

(57) ABSTRACT

A camera monitoring system (CMS) may include a camera mounted on a vehicle and positioned to capture the trailer landing gear within its field of view. The system may also include processing circuitry connected to memory, designed to store at least one reference image of the landing gear in a predefined position. Upon receiving a new image from the camera, the processing circuitry may compare the image to the stored reference image(s) to determine whether the landing gear matches one of the predefined positions.

### BACKGROUND

Mirror replacement systems, and camera systems for supplementing mirror views, are utilized in commercial vehicles to enhance the ability of a vehicle operator to see a surrounding environment. Camera monitor systems (CMS) utilize one or more cameras disposed about the vehicle to provide an enhanced field of view to a vehicle operator on one or more displays located in the vehicle cabin. In some examples, mirror replacement systems within the CMS can cover a larger field of view than a conventional mirror, or can include views that are not fully obtainable via a conventional mirror.

A trailer landing gear is the retractable support equipment that keeps a trailer level when removed from the tractor. The trailer landing gear is typically located at the front of the trailer and includes two legs that can support the weight of the trailer and can be manually or automatically raised and lowered. Some may include a gearbox and crank handle for manually raising or lowering the legs.

### SUMMARY

In some aspects, the techniques described herein relate to a method, including capturing at least one model image including a trailer landing gear of a vehicle; storing the at least one model image; classifying the at least one model image as showing one of number of discrete positions of the trailer landing gear; capturing a second image including the trailer landing gear; comparing the second image to the at least one model image; determining whether the trailer landing gear in the second image is in one of the number of discrete positions; and notifying an operator that the trailer landing gear is in one of the number of discrete positions based on the determining step.

In some aspects, the techniques described herein relate to a method, and the capturing at least one model image step includes capturing a plurality of model images including the trailer landing gear.

In some aspects, the techniques described herein relate to a method, including preprocessing the second image to match a format of the at least one model image.

In some aspects, the techniques described herein relate to a method, including displaying the second image on a display in a tractor of the vehicle.

In some aspects, the techniques described herein relate to a method, and the number of discrete positions includes an extended position and a retracted position, and the determining step includes determining whether the trailer landing gear is in the extended position or the retracted position.

In some aspects, the techniques described herein relate to a method, including generating a confidence score as to whether the trailer landing gear is in the extended position or the retracted position based on the comparing; and at least one of (i) notifying the operator that the trailer landing gear is in one of the extended position or the retracted position if the confidence score is above a threshold value, and (ii) notifying the operator that the trailer landing gear is in the other of the extended position or the retracted position if the confidence score is below the threshold value.

In some aspects, the techniques described herein relate to a method, and the number of discrete positions includes a handle actuation position and a handle stowed position, and the determining step includes determining whether the trailer landing gear is in the handle actuation position or the handle stowed position.

In some aspects, the techniques described herein relate to a method, and the number of discrete positions includes an extended position, a retracted position, a handle actuation position, and a handle stowed position.

In some aspects, the techniques described herein relate to a method, the method including displaying a status associated with the number of discrete positions on a display in a tractor of the vehicle.

In some aspects, the techniques described herein relate to a method, and the determining step includes detecting the position of a marker on the trailer landing gear.

In some aspects, the techniques described herein relate to a camera monitor system (CMS), including a camera mounted to a vehicle and positioned to capture a field of view including a trailer landing gear; and processing circuitry operatively connected to memory and configured to store at least one model image of the field of view with the trailer landing gear classified in one of a number of discrete positions; receive a captured second image from the camera; and determine whether the trailer landing gear is in one of the number of discrete positions based on comparison of the second image to the at least one model image.

In some aspects, the techniques described herein relate to a CMS, and the number of discrete positions includes an extended position, a retracted position, a handle actuation position, and a handle stowed position.

In some aspects, the techniques described herein relate to a CMS, and the processing circuitry is configured to determine whether the trailer landing gear is the extended position or the retracted position based on comparison of the second image to the at least one model image.

In some aspects, the techniques described herein relate to a CMS, and the processing circuitry is configured to notify an operator whether the trailer landing gear is in the extended position or the retracted position based on the determination.

In some aspects, the techniques described herein relate to a CMS, and the processing circuitry is configured to determine whether the trailer landing gear is the handle actuation position or the handle stowed position based on comparison of the second image to the at least one model image.

In some aspects, the techniques described herein relate to a CMS, and the camera is mounted to a trailer of the vehicle.

In some aspects, the techniques described herein relate to a CMS, and the camera is mounted to a tractor of the vehicle.

In some aspects, the techniques described herein relate to a CMS, including a display for displaying the second image.

In some aspects, the techniques described herein relate to a CMS, including a display for displaying a status indicative of a current position of the number of discrete positions.

In some aspects, the techniques described herein relate to a CMS, and the processing circuitry is configured to notify an operator whether the trailer landing gear is in one of the number of discrete positions based on the determining.

These and other features may be best understood from the following specification and drawings, the following of which is a brief description.

### BRIEF DESCRIPTION OF THE DRAWINGS

FIG. 1 is a schematic front view of a commercial truck with a camera mirror system (CMS) used to provide at least narrow and wide fields of view alongside the vehicle (e.g., Class II and Class IV views).

FIG. 2 is a schematic birds-eye view of the commercial truck of FIG. 1 with a CMS providing, for example, Class II, Class IV, Class V, and Class VI views.

FIG. 3 is a schematic top view of an example vehicle cabin interior.

FIG. 4 is a perspective view of an example vehicle cabin interior.

FIG. 5A illustrates an image from the example field of view of the example landing gear camera in the example CMS.

FIG. 5B illustrates another image from the example field of view of the example landing gear camera in the example CMS.

FIG. 6 schematically illustrates an example mounting position for the example landing gear camera.

FIG. 7 schematically illustrates another example mounting position for the example landing gear camera.

FIG. 8 schematically illustrates another example mounting position for the example landing gear camera.

FIG. 9 schematically illustrates another example mounting position for the example landing gear camera.

FIG. 10 schematically illustrates another example mounting position for the example landing gear camera.

FIG. 11 is a flowchart of an example method in accordance with this disclosure.

### DETAILED DESCRIPTION

This disclosure relates generally to utilizing a CMS to gather information about a trailer landing gear. More specifically, this disclosure relates to utilizing a CMS to determine whether a trailer landing gear is in one or more of a number of discrete positions.

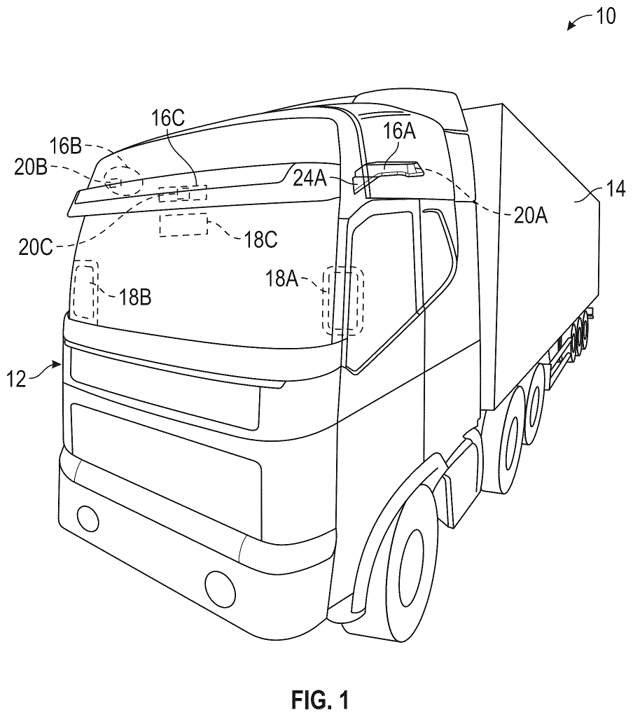

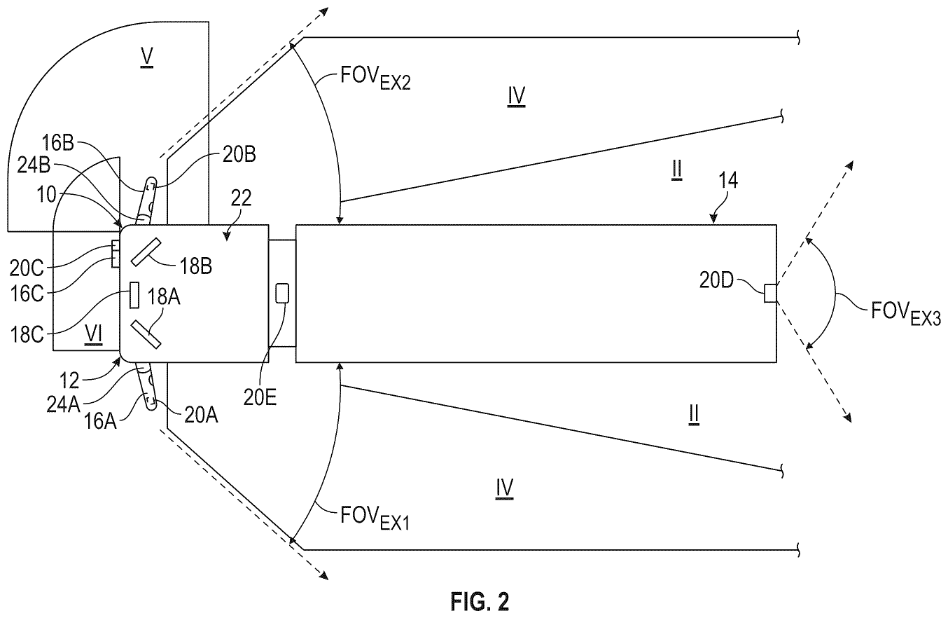

A schematic view of a commercial vehicle 10 is illustrated in FIGS. 1-2. The vehicle 10 includes a vehicle cab or “tractor” 12 for pulling a trailer 14. Although the vehicle 10 is depicted as a commercial truck in this disclosure, it is understood that other types of vehicles may be used, and it should be understood that other configurations may be utilized for the vehicle cab 12 and/or trailer 14 (e.g., different types or quantities of trailers).

Referring now to FIGS. 1 and 2, camera arms 16A-B may each include a respective base 24A-B that is secured to, for example, the tractor 12. The pivoting camera arms 16A-B are supported by the respective bases 24A-B and may articulate relative thereto. At least one rearward facing camera 20A-B is arranged respectively on or within the camera arms 16A-B. The exterior cameras 20A-B respectively provide an exterior field of view FOV_{EX1}, FOV_{EX2} that each include at least one of Class II and Class IV views (see FIG. 2), which are legally prescribed views in the commercial trucking industry. Although rotatable camera arms 16 are depicted, it is understood that this is a non-limiting example and that non-rotatable camera arms may be used.

The Class II view on a given side of the commercial vehicle 10 is a subset of the class IV view of the same side of the commercial vehicle 10. Multiple cameras also may be used in each camera arm 16A-B to provide these views, if desired. Class II (narrow) and Class IV (wide angle) views are defined in European R46 legislation, for example, and the United States and other countries have similar drive visibility requirements for commercial trucks. Any reference to a “Class” view is not intended to be limiting, but is intended as an example of the type of view provided to a display from a particular camera.

Each camera arm 16A-16B may also provide a housing that encloses electronics, e.g., a controller, that are configured to provide various features of the CMS 15. The camera arms 16A-B may be mounted either at a roof-mount location over the cab door (as shown in FIG. 1), or on a door-mounted bracket or station, for example. If desired, the camera arms 16A-B may include conventional mirrors integrated with them as well, although the CMS 15 may be used to entirely replace mirrors. In additional examples, each side can include multiple camera arms, with each arm housing one or more cameras and/or mirrors.

If video of Class V and/or Class VI views is also desired, a camera housing 16C and camera 20C may be arranged at or near the front of the commercial vehicle 10 to provide those views (FIG. 2).

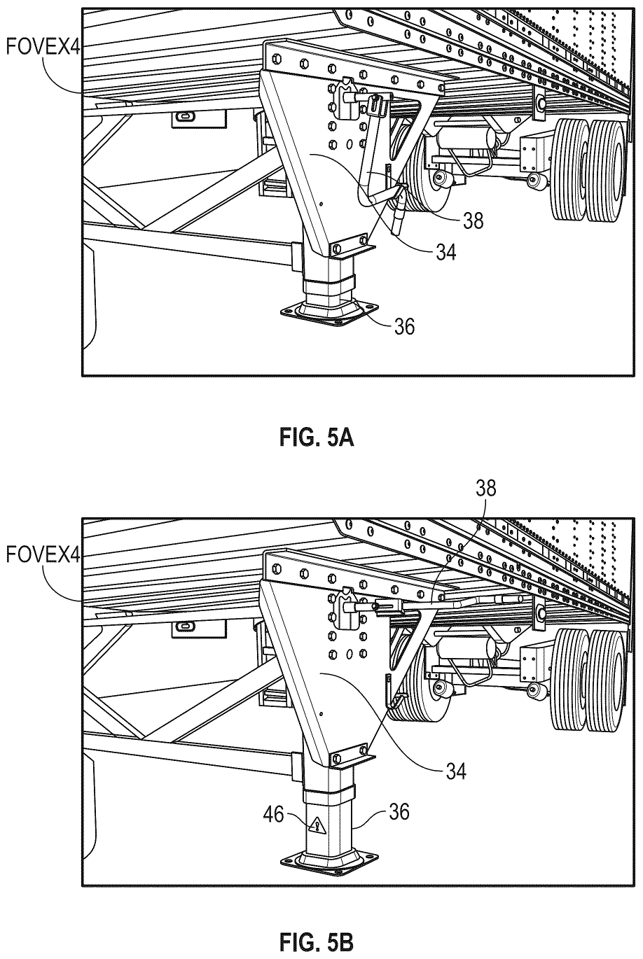

A backup camera 20D may be provided which provides a field of view FOV_{EX3}. The backup camera 20D may be mounted at a top/centerline of the trailer, at a bumper/bed level of the trailer, or at a top-corner of the back of the trailer, for example. A landing gear camera 20E may be mounted to the vehicle to provide a field of view FOV_{EX4} (see, e.g., FIG. 5A) of the landing gear 34 of the trailer.

FIGS. 5A and 5B illustrate an example field of view FOV_{EX4} of the example landing gear camera 20E inclusive of the landing gear 34. The field of view FOV_{EX4} may include one or both of the legs 36 and a handle 38 of the landing gear 34. The landing gear camera 20E may be positioned to capture one or more images of the landing gear 34 in one or both of a retracted and extended positions. The retracted position (e.g., FIG. 5A) is when the landing gear 34 is fully raised, keeping the legs 36 tucked under the trailer 14 for ground clearance during travel. The extended position (e.g., FIG. 5B) is when the legs are fully lowered, such as for supporting the trailer 14 when it is parked and uncoupled from the tractor 12. The landing gear camera 20E may additionally or alternatively be positioned to capture one or more images of the handle 38 in a handle actuation position (FIG. 5B) or a handle stowed position (FIG. 5A). FIGS. 5A and 5B show one example field of view FOV_{EX4}, but the camera 20E may be positioned differently in some examples, such as to capture other angles of the landing gear 34.

Although FIG. 5A shows the landing gear 34 in a retracted and handle stowed position, other images may show the landing gear 34 in a retracted and handle actuated position. Although FIG. 5B shows the landing gear 34 in an extended and handle actuated position, other images may show the landing gear 34 in an extended and handle stowed position. Further, although the example images show landing gear 34 with a handle, other vehicles with other configurations of landing gears 34, such as those without handles, will benefit from this disclosure.

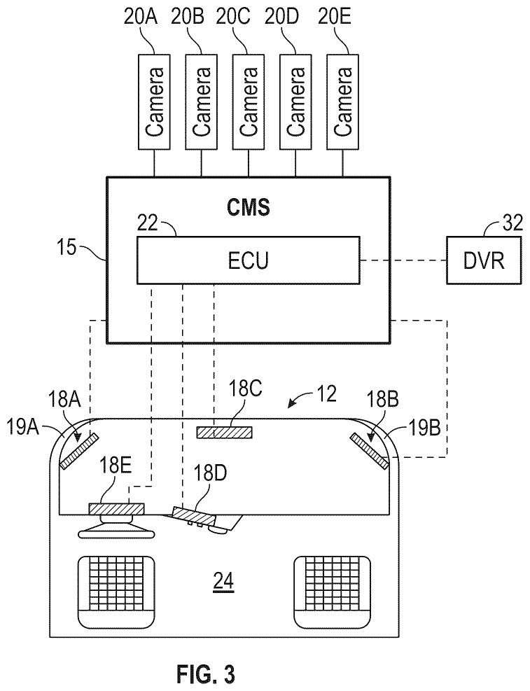

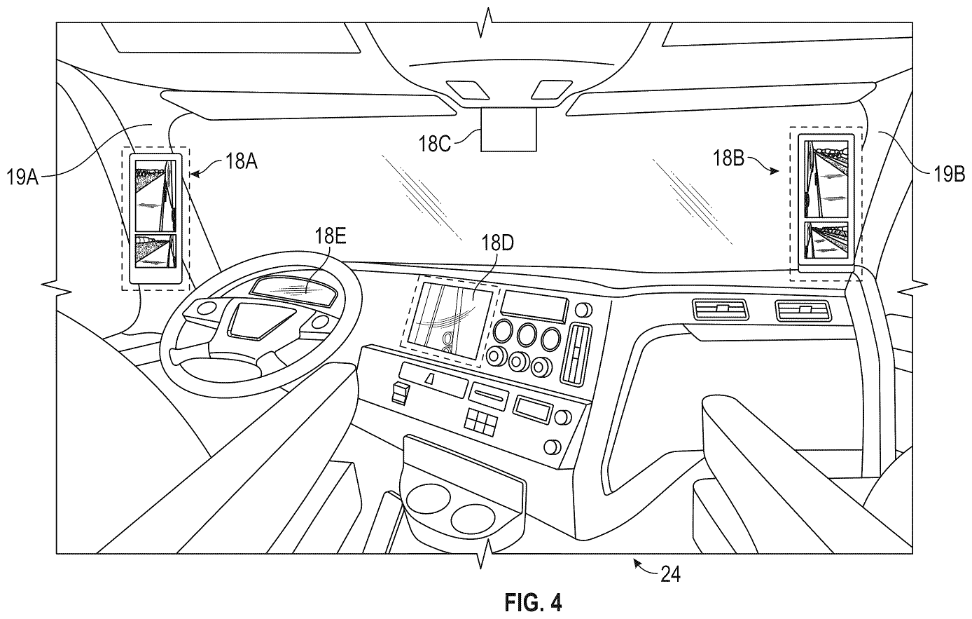

FIG. 3 is a schematic top view of an example vehicle cabin interior 26, and FIG. 4 is a perspective view of the vehicle cabin interior 26. Referring now to FIGS. 3-4 with continued reference to the preceding figures, electronic displays 18A-E (e.g., which may be video displays, such as LCD displays) and cameras 20A-E are shown. The various electronic displays 18A-E and cameras 20A-E are part of a camera monitor system (CMS) 15, and therefore act as CMS displays and CMS cameras. As used herein, a “CMS camera” 20 is a camera configured to record images of an environment surrounding a commercial vehicle 10, and a “CMS display” 18 is an electronic display (e.g., an LCD) that is configured to display image feeds from those cameras.

The CMS 15 includes a CMS electronic control unit (ECU) 22 that acts as a controller and includes processing circuitry that supports operation of the CMS 15. The CMS ECU 22 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The ECU 22 is configured to be compatible with a variety of different cameras, including, e.g., cameras with different resolutions (e.g., 3-8 megapixels), cameras that utilize different communication standards, and cameras that include or omit IR illumination. A digital video recorder (DVR) 32 or other data recorder may also be in communication with the ECU 22 for storing vehicle data, including video recordings, which may then be uploaded to the cloud or a fleet operator.

The CMS displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged in the vehicle cabin interior 26 near the top center of the windshield and may be used to display the Class V and Class VI views, which are toward the front of the commercial vehicle 10, or a backup camera view (from camera 20D) to the driver. Display 18D is provided in a center console area of the vehicle cabin interior 26, and may be used for other purposes, such as navigation, infotainment, etc. Display 18E may be part of an instrument cluster, for example. The displays 18A-E face a driver region within the vehicle cabin interior 26 where an operator is seated on a driver seat.

The CMS 15 may be utilized to determine the position of the trailer landing gear 34. In implementations, the landing gear camera 20E may be used to detect the position of one or more of the legs 36 and the handle 38 of the trailer landing gear 34. As one illustrative example, the CMS 15 may be utilized to determine whether the landing gear 34 is in the extended or retracted position. In some implementations, a determination of whether landing gear 34 is in the extended or retracted position is performed during a vehicle pre-trip inspection, a detailed check performed before operating the vehicle 10 to ensure that it is in safe and proper working condition. Other phases of vehicle operation, including while the vehicle 10 is moving, would benefit from this disclosure.

Similarly, the CMS 15 may additionally or alternatively be used to determine whether the landing gear 34 is in the handle actuation position or the handle stowed position. In implementations, the disclosed position detections may be utilized to prevent potential trailer damage or introduce hazards, for instance where the trailer landing gear 34 hits the ground when driving over uneven terrain.

The landing gear camera 20E may be mounted to the vehicle 10 and positioned to capture a field of view including the trailer landing gear 34. The field of view may include one or more of the legs 36 and a handle 38 of the landing gear 34. The landing gear camera 20E can be mounted in various locations to optimize its field of view, including on the tractor 12 or trailer 14.

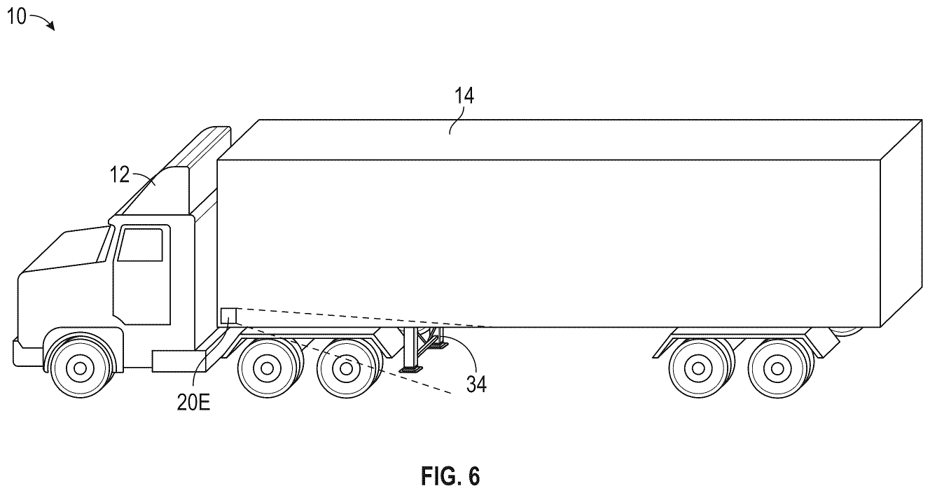

In implementations, as shown schematically in FIG. 6, the landing gear camera 20E may be mounted to the trailer 14 near the nose of the trailer 14. In implementations, the landing gear camera 20E may be mounted on the driver's side of the vehicle. In implementations, the landing gear camera 20E may be on the bottom side rails or side skirts of the trailer.

In implementations in which the landing gear camera 20E is mounted to the trailer 14, data may be communicated between the trailer 14 and the tractor 12 by use of a data communications system between the tractor 12 and trailer 14. Examples of such systems are disclosed in PCT/US2022/034710, entitled “TRAILER CAMERA COMMUNICATIONS SYSTEM”, published on Dec. 29, 2022, and U.S. patent application Ser. No. 18/657,104 entitled “TRAILER CAMERA COMMUNICATIONS SYSTEM”, filed on May 7, 2024, both of which are incorporated by reference in their entirety.

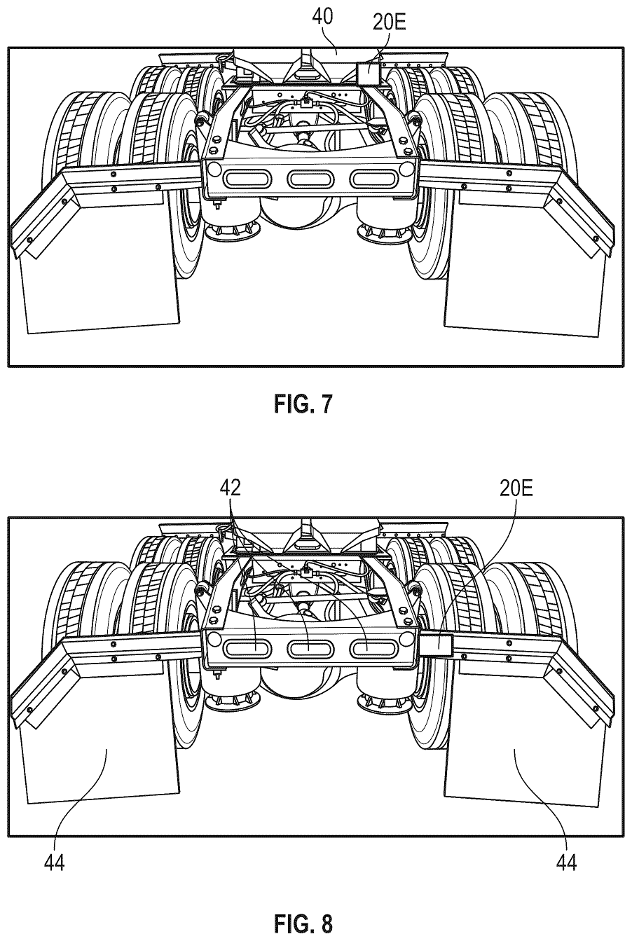

In implementations, as shown schematically in FIG. 7, the landing gear camera 20E may be adjacent to or mounted to the fifth wheel plate 40.

In implementations, the landing gear camera 20E may be mounted to the tractor 12, such as near the rear lights 42 and/or mudflaps 44, as shown schematically in FIG. 8.

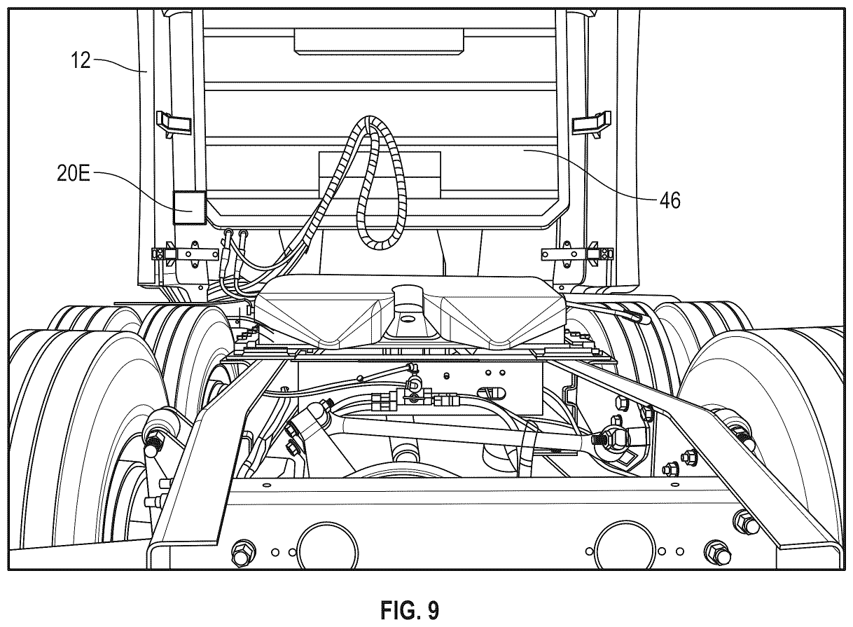

In implementations, as shown schematically in FIG. 9, the landing gear camera 20E may be mounted to the rear panel 46 of the tractor 12.

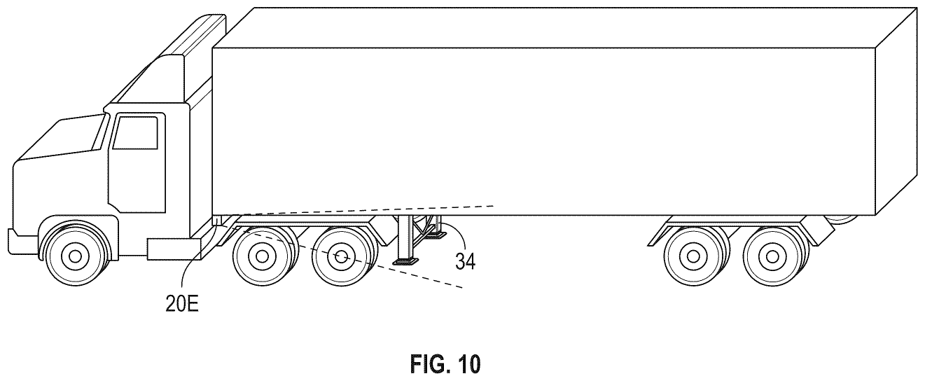

In implementations, as shown schematically in FIG. 10, the landing gear camera 20E may be mounted underneath the trailer 14. Other positions of the camera 20E than are shown in the illustrative examples are contemplated. In implementations, more than one camera 20E may be utilized to capture images of the trailer landing gear.

The CMS 15 may utilize one or more of machine vision techniques, neural networks, and signal processing algorithms (e.g., including Kalman filters, edge detection, and deep learning-based object recognition) to accurately assess the status of the landing gear. The CMS 15 may apply real-time image processing to determine the current state of the landing gear. The processing circuitry of the CMS 15 may receive one or more images from the landing gear camera 20E and process the images using one or more of the computer vision algorithms disclosed herein.

The CMS 15 may capture images and apply real-time image processing to determine the landing gear's current state. As one example, the CMS 15 may utilize edge detection and contour analysis algorithms to identify the geometric shape of the landing gear by analyzing contrasts and edges in the image. Edge detection may be utilized to distinguish the trailer landing gear 34 from the surrounding environment based on contrast variations and object boundaries. As another example, the CMS 15 may utilize deep learning and neural networks, which may be trained on a dataset of one or more landing gear images with classified landing gear positions. As another example, the CMS 15 may utilize Kalman Filtering for motion tracking to predict the trajectory of the landing gear movement, while filtering out noise even in dynamic conditions, such as vibrations from the truck engine or motion blur. These examples may be used alone or in combination with one another.

The processed data can be integrated with onboard communications in the vehicle and/or fleet management platforms to provide alerts regarding the trailer landing gear status and position.

As illustrated in FIG. 5B, one or more markers 46 (e.g., a reflective or non-reflective decal) may also be applied to the leg 36 to help provide a visual reference to driver and/or the computer vision algorithms. In implementations, the marker 46 acts as a quick visual reference during pre-trip inspections, helping them easily verify the status of the landing gear 34. In implementations, a reflective marker may enhance visibility in low-light environments, such as during nighttime operations or in poorly lit areas. In implementations, the marker 46 could be color-coded or marked with height indicators for better clarity.

For the computer vision algorithms, the marker 46 may serve as a distinctive feature for detecting the position of the landing gear 34. By acting as a consistent reference point, the marker 46 allows the CMS 15 to track the movement of the landing gear 34.

The CMS 15 may capture and store one or more model images of the landing gear 34, which may be taken by the camera 20E in implementations. The model images may include one or more images of the landing gear classified in one or more of a number of discrete positions, such as an extended position, a retracted position, a handle actuation position, and a handle stowed position. FIGS. 5A and 5B show example model images.

In implementations, the classified model images may be utilized as a dataset to train a deep neural network model to classify whether a captured image shows a landing gear in an extended position or a retracted position, which may be deployed to the ECU 22. In implementations, the classified model images may be utilized as a dataset to train a deep neural network model to classify whether a captured image shows a landing gear in a handle actuation position or a handle stowed position, which may be deployed to the ECU 22.

The CMS 15 may capture a current image of the landing gear and compare the captured image to one or more model images. The image may be captured with the camera 20E. In some implementations, the CMS 15 may preprocess (e.g., crop, resize, normalization) the captured image to match a format of the at least one model image. In implementations, the captured image may be displayed within one of the aforementioned displays 18. In implementations, the detected position of the landing gear in the captured image may be displayed within one of the aforementioned displays 18.

The CMS 15 may determine whether the landing gear 34 in the captured image is in an extended position or a retracted position based on the comparison. The determination may include assigning a confidence level or score to the captured image indicative of landing gear 34 in a specific position.

The CMS 15 may determine whether the landing gear 34 in the captured image is in a handle actuation position or a handle stowed position based on the comparison. The determination may include assigning a confidence level or score to the captured image indicative of the landing gear 34 being in a specific position.

Additionally or alternatively for determining the position of the landing gear 34, the CMS 15 may utilize edge detection and contour analysis to identify edges of the landing gear 34 based on contrast differences in the image. In implementations, by analyzing the shape, position, and alignment of detected edges relative to reference points (e.g., fixed reference points on the trailer 14), the CMS 15 can infer whether the landing gear 34 is extended or retracted and/or in a handle actuation or handle stowed position.

Additionally or alternatively for determining the position of the landing gear 34, the CMS 15 may utilize color and pattern recognition, such as to detect the position of the marker 46 or other features of the landing gear 34, to determine the position of the landing gear 34. For example, by defining specific areas in the image where the marker 46 should appear in extended or retracted positions, the CMS 15 can determine the landing gear position.

Based on the determination of the landing gear position, the CMS 15 may notify an operator which position the landing gear 34 is in. In implementations, the CMS 15 may generate a confidence score as to which position the landing gear 34 is in, and notify the operator if the confidence score is above or below a threshold value. Additionally or alternatively, the CMS 15 may then notify the operator of the confidence score.

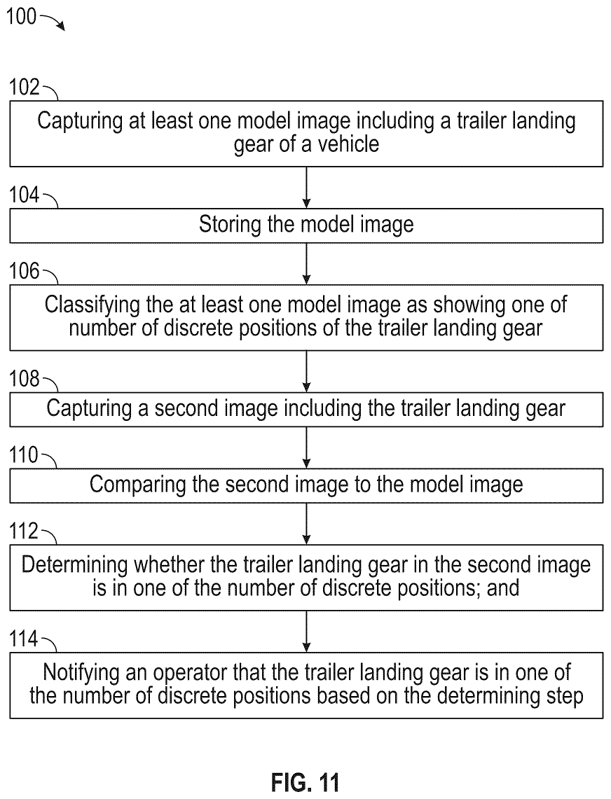

FIG. 11 illustrates a flowchart of an example pre-trip inspection method 100. Fewer or additional steps than are recited below could be performed within the scope of this disclosure, and the recited order of steps is not intended to limit this disclosure. At 102, the method 100 may include capturing at least one model image including a trailer landing gear of a vehicle. At 104, the method may include storing the model image.

At 106, the method 100 may include classifying the at least one model image as showing one of number of discrete positions of the trailer landing gear. These positions could include one or more of an extended position, a retracted position, a handle actuation position, and a handle stowed position.

At 108, the method 100 may include capturing a second image including the trailer landing gear.

At 110, the method 100 may include comparing the second image to the model image.

At 112, the method 100 may include determining whether the trailer landing gear in the second image is in one of the number of discrete positions.

At 114, the method 100 may include notifying an operator that the trailer landing gear is in one of the number of discrete positions based on the determination in step 112.

The ability of the CMS 15 to determine the trailer landing gear position may enhance one or both of safety and operational efficiency in applications by providing real-time monitoring and alerts. By integrating computer vision and/or sensor-based detection, the CMS 15 may aid in verifying that the landing gear is properly stowed before transit, preventing accidental deployment that could lead to road hazards, structural damage, or mechanical failure. Additionally, during a pre-trip inspection, the CMS 15 may automate the verification process. Continuous monitoring during vehicle operation can prevent unexpected landing gear deployment due to vibrations, mechanical failure, improper stowage, etc., including on rough or uneven terrain for ground clearance.

A method according to one or more examples of this disclosure may be said to include capturing at least one model image including a trailer landing gear of a vehicle; storing the at least one model image; classifying the at least one model image as showing one of number of discrete positions of the trailer landing gear; capturing a second image including the trailer landing gear; comparing the second image to the at least one model image; determining whether the trailer landing gear in the second image is in one of the number of discrete positions; and notifying an operator that the trailer landing gear is in one of the number of discrete positions based on the determining step.

In implementations, the capturing of a model image step includes capturing multiple model images including the trailer landing gear. In implementations, the method includes preprocessing the second image to match a format of the model image. In implementations, the method includes displaying the second image on a display in a tractor of the vehicle.

In implementations, the number of discrete positions may include an extended position and a retracted position, and the determining step includes determining whether the trailer landing gear is in the extended position or the retracted position. In implementations, the method includes generating a confidence score as to whether the trailer landing gear is in the extended position or the retracted position based on the comparing; and at least one of (i) notifying the operator that the trailer landing gear is in one of the extended position or the retracted position if the confidence score is above a threshold value, and (ii) notifying the operator that the trailer landing gear is in the other of the extended position or the retracted position if the confidence score is below the threshold value.

In implementations, the number of discrete positions includes a handle actuation position and a handle stowed position, and the method includes determining whether the trailer landing gear is in the handle actuation position or the handle stowed position.

In implementations, the method includes displaying a status associated with the number of discrete positions on a display in a tractor of the vehicle.

In implementations, the method includes detecting the position of a marker on the trailer landing gear.

A method, according to one or more examples of this disclosure, may involve the following steps: capturing an initial reference image that includes the trailer landing gear of a vehicle; storing the reference image for future comparison; categorizing the reference image as representing one of multiple defined landing gear positions; capturing a subsequent image of the trailer landing gear; analyzing and comparing the subsequent image against the stored reference image; determining whether the landing gear in the new image corresponds to one or more of the predefined positions; and alerting an operator regarding the detected landing gear position based on this determination.

A camera monitor system (CMS) according to one or more examples in this disclosure may be said to include: a camera mounted to a vehicle and positioned to capture a field of view including a trailer landing gear. The CMS may further include processing circuitry operatively connected to memory and configured to: store at least one model image of the field of view with the trailer landing gear classified in one of a number of discrete positions; receive a captured second image from the camera; and determine whether the trailer landing gear is in one of the number of discrete positions based on comparison of the second image to the at least one model image.

In implementations, the processing circuitry is configured to determine whether the trailer landing gear is the extended position or the retracted position based on comparison of the second image to the at least one model image. In implementations, the processing circuitry is configured to: notify an operator whether the trailer landing gear is in the extended position or the retracted position based on the determination.

In implementations, the processing circuitry is configured to determine whether the trailer landing gear is the handle actuation position or the handle stowed position based on comparison of the second image to the at least one model image.

In implementations, the camera is mounted to a trailer of the vehicle. In implementations, the camera is mounted to a tractor of the vehicle.

In implementations, the CMS includes a display for displaying the second image and/or displaying a status indicative of a current position of the number of discrete positions.

In implementations, the processing circuitry is configured to notify an operator whether the trailer landing gear is in one of the number of discrete positions based on the determining.

A camera monitoring system (CMS), as described in this disclosure, may include a camera mounted on a vehicle and positioned to capture the trailer landing gear within its field of view. The system may also include processing circuitry connected to memory, designed to store at least one reference image of the landing gear in a predefined position. Upon receiving a new image from the camera, the processing circuitry may compare it to the stored reference image(s) to determine whether the landing gear matches one of the predefined positions.

The foregoing description shall be interpreted as illustrative. A worker of ordinary skill in the art would understand that certain modifications could come within the scope of this disclosure. Various examples of the disclosure have been described. Any combination of the described systems, operations, or functions is contemplated. It is possible to use some of the components or features from any of the examples in combination with features or components from any of the other examples. These and other examples are within the scope of the following claims.

What is claimed is:

1. A method, comprising:
capturing at least one model image including a trailer landing gear of a vehicle;
storing the at least one model image;
classifying the at least one model image as showing one of number of discrete positions of the trailer landing gear;
capturing a second image including the trailer landing gear;
comparing the second image to the at least one model image;
determining whether the trailer landing gear in the second image is in one of the number of discrete positions; and
notifying an operator that the trailer landing gear is in one of the number of discrete positions based on the determining step.

2. The method of claim 1, wherein the capturing at least one model image step includes capturing a plurality of model images including the trailer landing gear.

3. The method of claim 1, comprising:
preprocessing the second image to match a format of the at least one model image.

4. The method of claim 1, comprising:
displaying the second image on a display in a tractor of the vehicle.

5. The method of claim 1, wherein the number of discrete positions includes an extended position and a retracted position, and the determining step includes determining whether the trailer landing gear is in the extended position or the retracted position.

6. The method of claim 5, comprising:
generating a confidence score as to whether the trailer landing gear is in the extended position or the retracted position based on the comparing; and
at least one of (i) notifying the operator that the trailer landing gear is in one of the extended position or the retracted position if the confidence score is above a threshold value, and (ii) notifying the operator that the trailer landing gear is in the other of the extended position or the retracted position if the confidence score is below the threshold value.

7. The method of claim 1, wherein the number of discrete positions includes a handle actuation position and a handle stowed position, and the determining step includes determining whether the trailer landing gear is in the handle actuation position or the handle stowed position.

8. The method of claim 1, wherein the number of discrete positions includes an extended position, a retracted position, a handle actuation position, and a handle stowed position.

9. The method of claim 1, the method comprising:
displaying a status associated with the number of discrete positions on a display in a tractor of the vehicle.

10. The method of claim 1, wherein the determining step includes detecting the position of a marker on the trailer landing gear.

11. A camera monitor system (CMS), comprising:
a camera mounted to a vehicle and positioned to capture a field of view including a trailer landing gear; and
processing circuitry operatively connected to memory and configured to:
store at least one model image of the field of view with the trailer landing gear classified in one of a number of discrete positions;
receive a captured second image from the camera; and
determine whether the trailer landing gear is in one of the number of discrete positions based on comparison of the second image to the at least one model image.

12. The CMS of claim 11, wherein the number of discrete positions includes an extended position, a retracted position, a handle actuation position, and a handle stowed position.

13. The CMS of claim 12, wherein the processing circuitry is configured to determine whether the trailer landing gear is the extended position or the retracted position based on comparison of the second image to the at least one model image.

14. The CMS of claim 13, wherein the processing circuitry is configured to: notify an operator whether the trailer landing gear is in the extended position or the retracted position based on the determination.

15. The CMS of claim 12, wherein the processing circuitry is configured to determine whether the trailer landing gear is the handle actuation position or the handle stowed position based on comparison of the second image to the at least one model image.

16. The CMS of claim 11, wherein the camera is mounted to a trailer of the vehicle.

17. The CMS of claim 11, wherein the camera is mounted to a tractor of the vehicle.

18. The CMS of claim 11, comprising a display for displaying the second image.

19. The CMS of claim 11, comprising:
a display for displaying a status indicative of a current position of the number of discrete positions.

20. The CMS of claim 11, wherein the processing circuitry is configured to:
notify an operator whether the trailer landing gear is in one of the number of discrete positions based on the determining.
